(19) United States
(12) Patent Application Publication
(10) Pub. No.: US 2010/0085291 A1
(43) Pub. Date: Apr. 8, 2010

(54) LCD with two-dot inversion

(76) Inventors: Yun-Chung Lin, Hsin-Chu (TW); Fang-Lin Chang, Hsin-Chu (TW); Chung-Lung Li, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/357,420

(22) Filed: Jan. 22, 2009

(30) Foreign Application Priority Data
Oct. 8, 2008 (TW) 097138668

(51) Int. Cl. G09G 3/36

(52) U.S. Cl. 345/92; 345/94

(57) ABSTRACT

An LCD with two-dot inversion includes plural gate lines for transmitting gate driving signals, plural data lines for transmitting data driving signals, and a pixel array. The pixel array includes plural pixels. The plural pixels display frames according to the received gate driving signals and data driving signals. A first data line of the plural data lines is coupled to a first column of pixels and a second column of pixels. The plural data lines are curves with several bends. The difference between the numbers of the first and the second columns is at least two.

### BACKGROUND OF THE INVENTION

1. Field of the Invention

The present invention relates to a Liquid Crystal Display (LCD), and more particularly, to an LCD with two-dot inversion capable of saving power consumption.

2. Description of the Prior Art

Please refer to FIG. 1. FIG. 1 is a diagram illustrating a conventional LCD 100. As shown in FIG. 1, The LCD 100 comprises a gate driving circuit 110, a data driving circuit 120 and a pixel area 130.

The gate driving circuit 110 comprises a plurality of gate lines G₁˜G_{N} for generating gate driving signals S_{G1}˜S_{GN} in order. The data driving circuit 120 comprises a plurality of data lines D₁˜D_{M} for generating data driving signals S_{D1}˜S_{DM}. Each of the gate lines G₁˜G_{N} is a straight line parallel with each other and each of the data line D₁˜D_{M} is a straight line parallel with each other. The pixel area 130 comprises a pixel array with M columns and N rows. The pixel array comprises (M×N) pixels P₁₁˜P_{MN}. The pixels of the pixel array are interwoven by the gate lines G₁˜G_{N} across the data lines D₁˜D_{M} and are driven by the gate driving signals generated by the corresponding gate lines for receiving the data driving signals generated by the corresponding data lines. For example, when the pixel P₁₁ receives the gate driving signal S_{G1}, the pixel P₁₁ receives the data signal S_{D1} so as to display the image. When the pixel P₁₂ receives the gate driving signal S_{G2}, the pixel P₁₂ receives the data signal S_{D1} so as to display the image. When the pixel P₂₁ receives the gate driving signal S_{G1}, the pixel P₂₁ receives the data signal S_{D2} so as to display the image. When the pixel P₂₂ receives the gate driving signal S_{G2}, the pixel P₂₂ receives the data signal S_{D2} so as to display the image, and so on.

Please refer to FIG.2 and FIG. 3 together. FIG. 2 and FIG. 3 are diagrams illustrating the conventional LCD 100 displaying images by dot inversion. In FIG. 2 and FIG. 3, the frame X and the frame (X+1) represents two successive frames. That is, the LCD 100 displays the frame (X+1) right after the frame X. As shown in FIG. 2 and FIG. 3, for the frames X and (X+1) having the characteristic of dot inversion, the polarity of the data driving signals carried by each data line have to be inverted (from positive to negative or from negative to positive) every time a gate driving signal passes by and the polarities of the data driving signals carried by the adjacent data lines are opposite to each other. For example, in the frame X, the polarity of the data driving signal S_{D1} during the interval of the gate driving signal S_{G1} is positive so that the display polarity of the pixel P₁₁ is positive. The polarity of the data driving signal S_{D1} during the interval of the gate driving signal S_{G2} is negative so that the display polarity of the pixel P₁₂ is negative. The data driving signal S_{D1} during the interval of the gate driving signal S_{G3} is positive so that the display polarity of the pixel P₁₃ is positive. The data driving signal S_{D1} during the interval of the gate driving signal S_{G4} is negative so that the display polarity of the pixel P₁₄ is negative. Relatively, the data driving signal S_{D2} carried by the data line D₂, which is adjacent to the data line D₁, is negative during the interval of the gate driving signal S_{G1} so that the display polarity of the pixel P₂₁ is negative. The data driving signal S_{D2} during the interval of the gate driving signal S_{G2} is positive so that the display polarity of the pixel P₂₂ is positive. The data driving signal S_{D2} during the interval of the gate driving signal S_{G3} is negative so that the display polarity of the pixel P₂₃ is negative. The data driving signal S_{D2} during the interval of the gate driving signal S_{G4} is positive so that the display polarity of the pixel P₂₄ is positive and so on. In such condition, the frame X having the characteristic of dot inversion is derived as shown in FIG. 2. In the frame (X+1) of FIG. 3, the polarities of all the data driving signals are inverted according to the polarities of all the data driving signals in the frame X and therefore the frame (X+1) having the characteristic of dot inversion is derived as shown in FIG. 3.

However, in the conventional LCD 100, since the gate lines are parallel with each other and the data lines are parallel with each other, and the gate lines are perpendicular across the data lines, for the purpose of displaying frame by dot inversion, the polarities of the data driving signals carried by the data lines have to be inverted every time a gate driving signal passes by, which causes too much power consumption and is quite inconvenient for the user.

### SUMMARY OF THE INVENTION

The present invention provides an LCD with two-dot inversion. The LCD comprises a plurality of gate lines, a plurality of data lines and a pixel array. The plurality of gate lines are utilized for transmitting gate driving signals. The plurality of data lines are utilized for transmitting data driving signals. The pixel array comprises a plurality of columns of pixels. Each row of the plurality of the columns of the pixels comprises a pixel so as to form the pixel array and the pixel array displays images according to the received gate driving signals and the received data driving signals. One of the plurality of the columns of the pixels is disposed between two adjacent gate lines and between two adjacent data lines. A first data line of the plurality of the data lines is coupled to pixels of a first column of a first pair of the plurality of the columns of the pixels and to pixels of a second column of a second pair of the plurality of the columns of the pixels, wherein the first column is separated from the second column by at least two columns.

The present invention further provides an LCD with two-dot inversion capable of saving power consumption. The LCD comprises a first, a second, a third and a fourth gate lines, a first and a second data lines, and a pixel array. The first, the second, the third and the fourth gate lines are utilized for transmitting gate driving signals. The first and the second data lines are utilized for transmitting data driving signals. The pixel array comprises a first, a second, a third, a fourth, a fifth and a sixth pixels. The first pixel is disposed at a first row and a first column of the pixel array. The first pixel is coupled to the first gate line and the first data line for displaying images according to the received gate driving signals and the received data driving signals. The second pixel is disposed at the first row and a second column of the pixel array. The second pixel is coupled to the second gate line and the first data line for displaying the images according to the received gate driving signals and the received data driving signals. The third pixel is disposed at the first row and a third column of the pixel array. The third pixel is coupled to the first gate line and the second data line for displaying the images according to the received gate driving signals and the received data driving signals. The fourth pixel is disposed at the first row and a fourth column of the pixel array. The fourth pixel is coupled to the second gate line and the second data line for displaying the images according to the received gate driving signals and the received data driving signals. The fifth pixel is disposed at a second row and the third column of the pixel array. The fifth pixel is coupled to the third gate line and the first data line for displaying the images according to the received gate driving signals and the received data driving signals. The sixth pixel is disposed at the second row and the fourth column of the pixel array. The sixth pixel is coupled to the fourth gate line and the first data line for displaying the images according to the received gate driving signals and the received data driving signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional Liquid Crystal Display (LCD).

FIG. 2 and FIG. 3 are diagrams illustrating the conventional LCD displaying images by dot inversion.

FIG. 4 is a diagram illustrating the LCD of the first embodiment of the present invention.

FIG. 5 and FIG. 6 are diagrams illustrating the LCD of the present invention displaying the image by two-dot inversion.

FIG. 7, FIG. 8 and FIG. 9 are diagrams illustrating the LCDs of the second, third and fourth embodiments of the present invention.

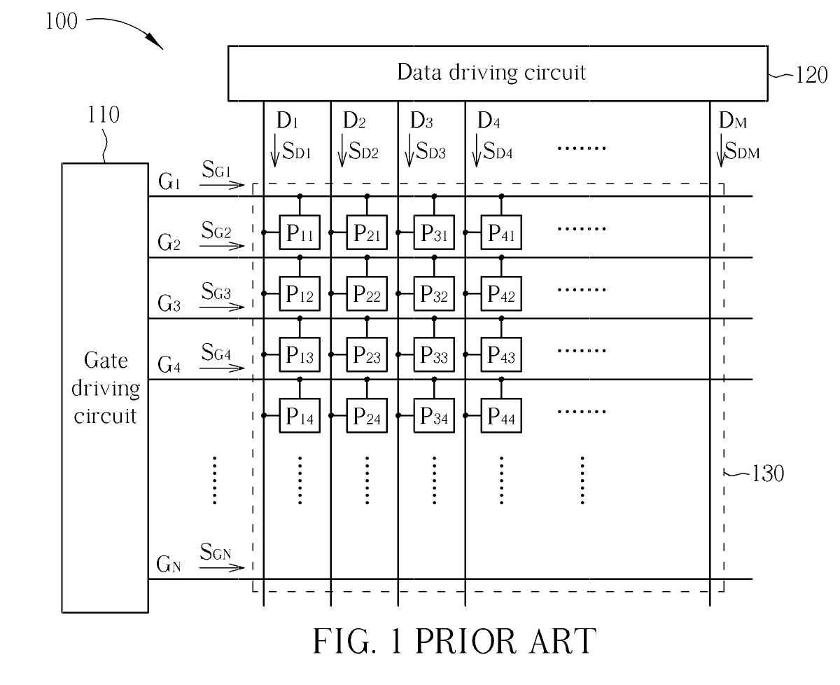

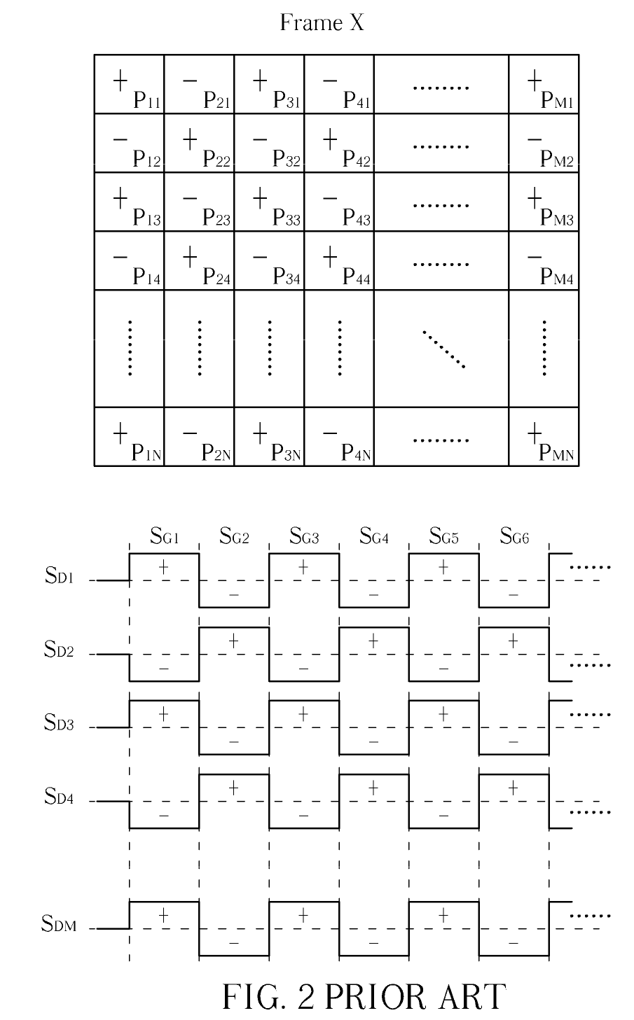

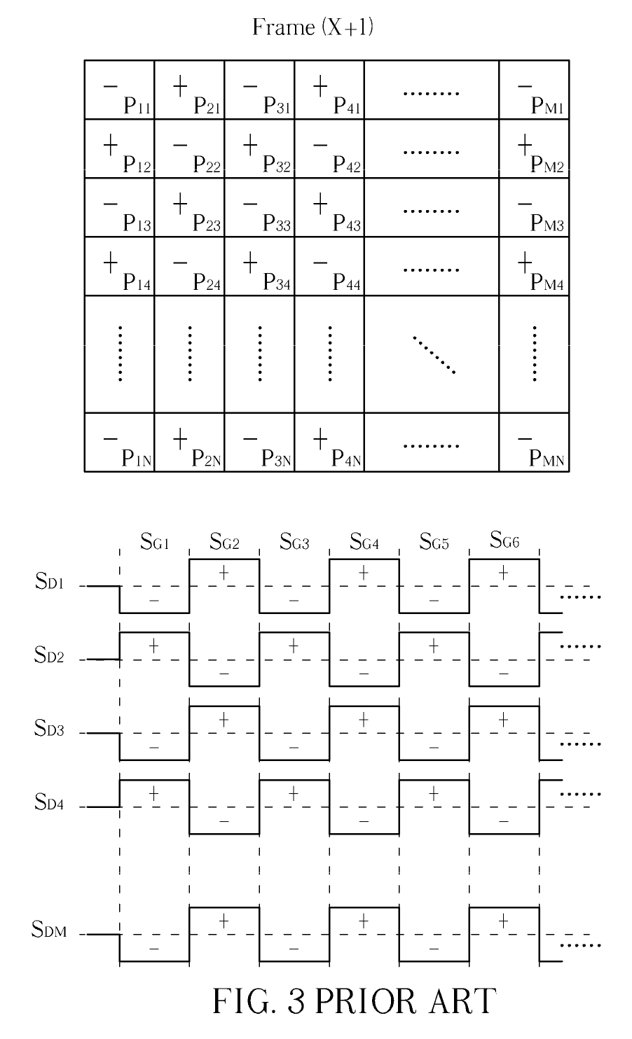

### DETAILED DESCRIPTION

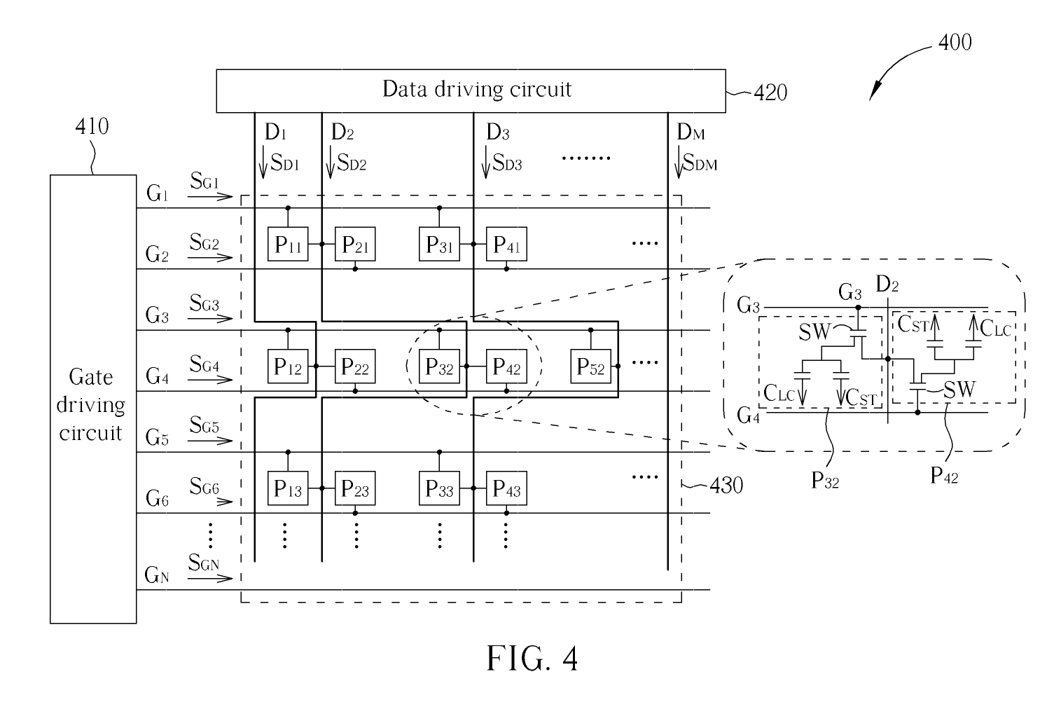

Please refer to FIG. 4. FIG. 4 is a diagram illustrating the LCD 400 of the first embodiment of the present invention. As shown in FIG. 4, the LCD 400 comprises a gate driving circuit 410, a data driving circuit 420, and a pixel area 430.

A gate driving circuit 410 comprises a plurality of gate lines G₁˜G_{N}. The gate driving circuit 410 is utilized for sequentially generating the gate driving signals S_{G1}˜S_{GN} and transmitting the gate driving signals S_{G1}˜S_{GN} respectively through the gate lines G₁˜G_{N}. The data driving circuit 420 comprises a plurality of data lines D₁˜D_{M}. The data driving circuit 420 is utilized for generating the data driving signal S_{D1}˜S_{DM} and transmitting the data driving signals S_{D1}˜S_{DM} respectively through the data lines D₁˜D_{M}. Each of the gate lines G₁˜G_{N} is a straight line parallel with each other. Each of the data line D₁˜D_{M} is designed as a curved line with a shape like the letter “S”. More particularly, the data lines designed by the present invention, in the pixel area 430, are curved with several bends between the two corresponding pair of columns of pixels. For example, the data lines D₂ is disposed between the first column of pixels and the second column of pixels (the first pair of columns of pixels), and the third column of pixels and the fourth column of pixels (the second pair of columns of pixels). More particularly, in the first row of the pixel area 430, the data line D₂ is disposed between the pixel P₁₁ and the pixel P₂₁ (the first pair of columns of pixels). In the second row of the pixel area 430, the data line D₂ is curved between the pixel P₃₂ and the pixel P₄₂ (the second pair of columns of pixels). In the third row of pixel area 430, the data line D₂ is curved back between the pixel P₁₃ and the pixel P₂₃ (the first pair of columns of pixels). In the fourth row of the pixel area 430, the data line D₂ is curved again between the pixel P₃₄ and the pixel P₄₄ (the second pair of columns of pixels) (not shown), and so on. The data line D₃ is disposed in the pixel area 430 between the third and fourth columns of pixels (the first pair of columns of pixels) and the fifth and sixth columns of pixels (the second pair of columns of pixels). More precisely, in the first row of the pixel area 430, the data line D₃ is disposed between the pixel P₃₁ and the pixel P₄₁ (the first pair of columns of pixels). In the second row of the pixel area 430, the data line D₃ is curved between the pixel P₅₂ and the pixel P₆₂ (the second pair of columns of pixels). In the third row of pixel area 430, the data line D₃ is curved back between the pixel P₃₃ and the pixel P₄₃ (the first pair of columns of pixels). In the fourth row of the pixel area 430, the data line D₃ is curved again between the pixel P₅₄ and the pixel P₆₄ (the second pair of columns of pixels) (not shown), and so on. The rest data lines are disposed in the similar way and hereinafter will not be repeated again.

The pixel area 430 comprises a pixel array with M columns and N rows. The pixel array comprises (M×N) pixels P₁₁˜P_{MN}. The pixels of the pixel array are interwoven by the gate lines G₁˜G_{N} across the data lines D₁˜D_{M} and are driven by the gate driving signals generated by the corresponding gate lines for receiving the data driving signals generated by the corresponding data lines. For instance, the pixel P₁₁ is coupled to the gate line G₁ and the data line D₂. When the pixel P₁₁ receives the gate driving signal S_{G1}, the pixel P₁₁ receives the data signal S_{D2} so as to display the image. The pixel P₂₁ is coupled to the gate line G₂ and the data line D₂. When the pixel P₂₁ receives the gate driving signal S_{G2}, the pixel P₂₁ receives the data signal S_{D2} so as to display the image. The pixel P₁₂ is coupled to the gate line G₃ and the data line D₁. When the pixel P₁₂ receives the gate driving signal S_{G3}, the pixel P₁₂ receives the data signal S_{D1} so as to display the image. The pixel P₂₂ is coupled to the gate line G₄ and the data line D₁. When the pixel P₂₂ receives the gate driving signal S_{G4}, the pixel P₂₂ receives the data signal S_{D1} so as to display the image. The pixel P₃₁ is coupled to the gate line G₁ and the data line D₃. When the pixel P₃₁ receives the gate driving signal S_{G1}, the pixel P₃₁ receives the data signal S_{D3} so as to display the image. The pixel P₄₁ is coupled to the gate line G₂ and the data line D₃. When the pixel P₄₁ receives the gate driving signal S_{G2}, the pixel P₄₁ receives the data signal S_{D3} so as to display the image, and so on. The pixel P₃₂ is coupled to the gate line G₃ and the data line D₂. When the pixel P₃₂ receives the gate driving signal S_{G3}, the pixel P₃₂ receives the data signal S_{D2} so as to display the image, and so on. In addition, each pixel (for example, the pixel P₃₂ and the Pixel P₄₂ of the FIG. 4) comprises a pixel switch SW, a liquid crystal capacitor C_{LC} and a storage capacitor C_{ST}. The pixel switch SW can be realized with a Thin Film Transistor (TFT), wherein the gate is the control end of the pixel switch. The control end C of the pixel switch SW of a pixel is coupled to the gate line corresponding to the pixel for receiving the corresponding gate driving signal. The first end 1 of the pixel switch SW is coupled to the data line corresponding to the pixel for receiving the corresponding data driving signal. The second end 2 of the pixel switch SW is coupled between the liquid crystal capacitor C_{LC} and the storage capacitor C_{ST}. The liquid crystal capacitor C_{LC} and the storage capacitor C_{ST} are coupled between the second end 2 of the pixel switch SW and a common end.

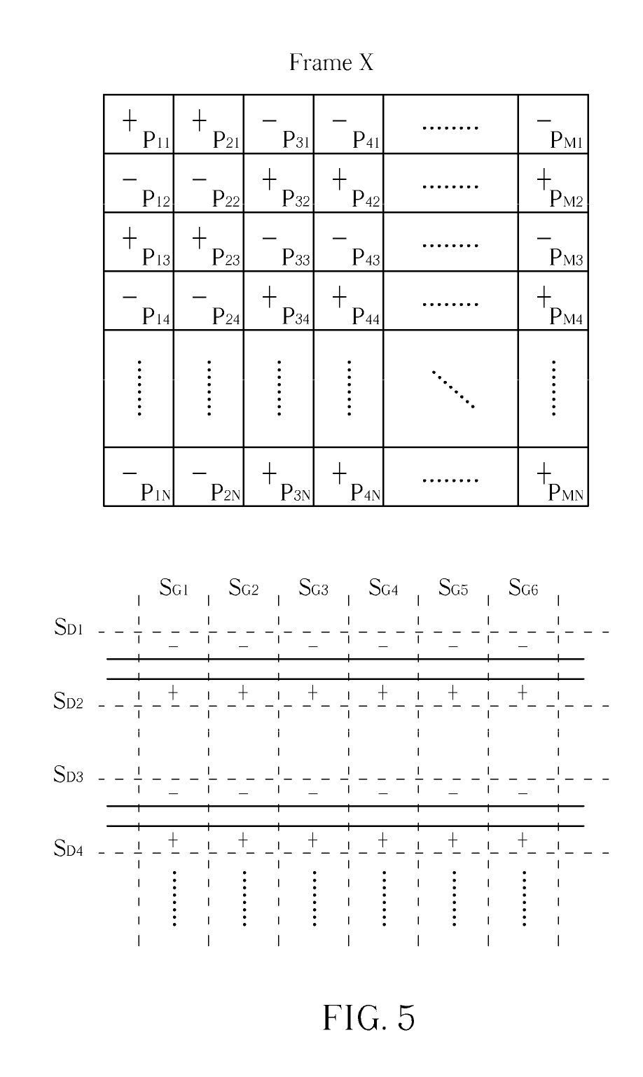

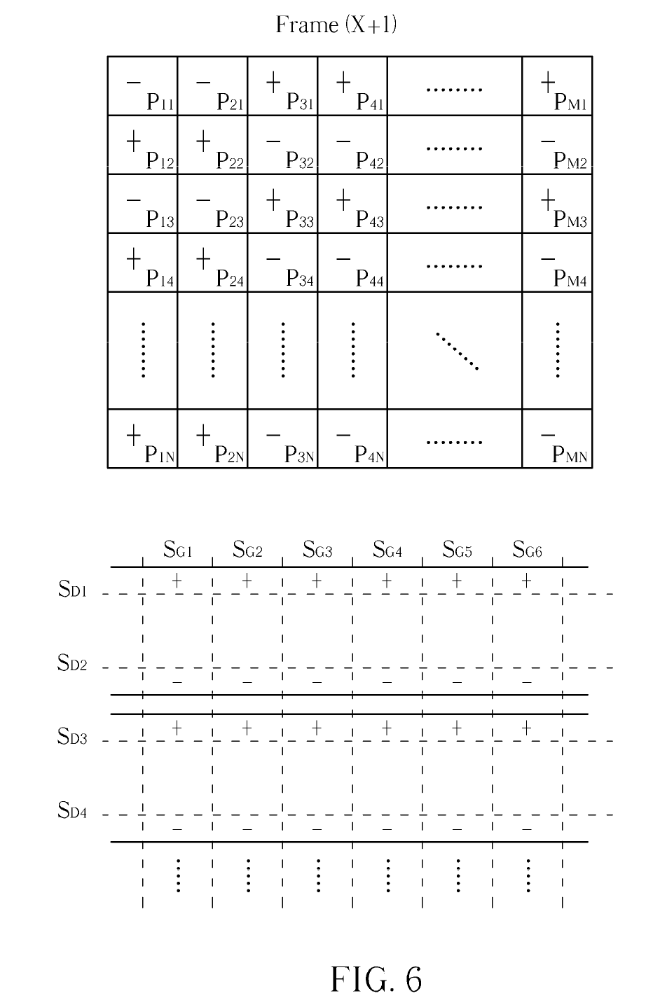

Please refer to FIG. 5 and FIG. 6 together. FIG. 5 and FIG. 6 are diagrams illustrating the LCD 400 of the present invention displaying images by two-dot inversion. In FIG. 5 and FIG. 6 the Frames X and (X+1) represent two successive frames. It means that the LCD 400 displays the frame (X+1) right after the frame X. As shown in FIG. 5 and FIG. 6, for the frames X and (X+1) having the characteristic of two-dot inversion, the polarities of the data driving signals carried by the adjacent data lines are opposite to each other. Since the data lines designed by the present invention have the shape like the letter “S”, the polarities of the data driving signals carried by a single line does not have to be inverted within one frame so that the power consumption of the LCD 400 can be saved. For example, during the period of displaying the frame X, the polarity of the data driving signal S_{D2} on the data line D₂ keeps positive so as to make the display polarities of the pixels P₁₁, P₂₁, P₃₂, P₄₂, P₁₃ and P₂₃ positive. Relatively, the polarity of the data driving signal S_{D3}, which is carried by the data line D₃ adjacent to the data line D₂, keeps negative so as to make the display polarities of the pixel P₃₁, P₄₁, P₁₂, P₂₂, P₃₃, P₄₃ negative, and so on. In this way, the frame X with the characteristic of two-dot inversion as shown in the upper part of FIG. 5 is derived. In the frame (X+1) of FIG. 6, the polarity of each data driving signal is inverted according to the polarity of the corresponding data driving signal so that the frame (X+1) with the characteristic of two-dot inversion as shown in the upper part of FIG. 6 is derived.

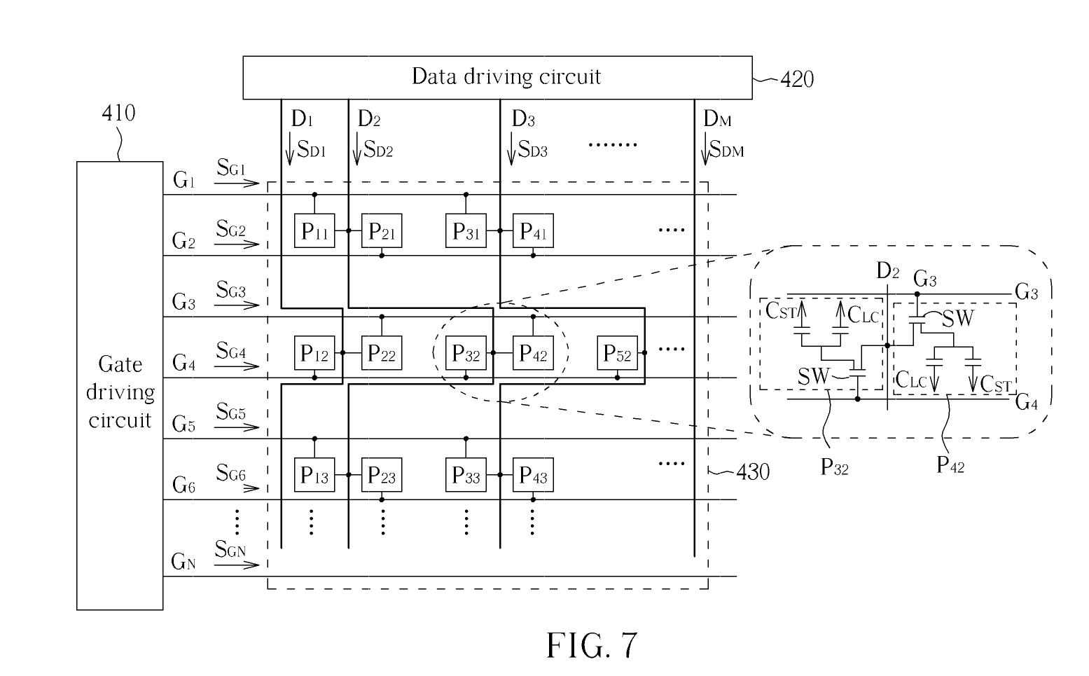

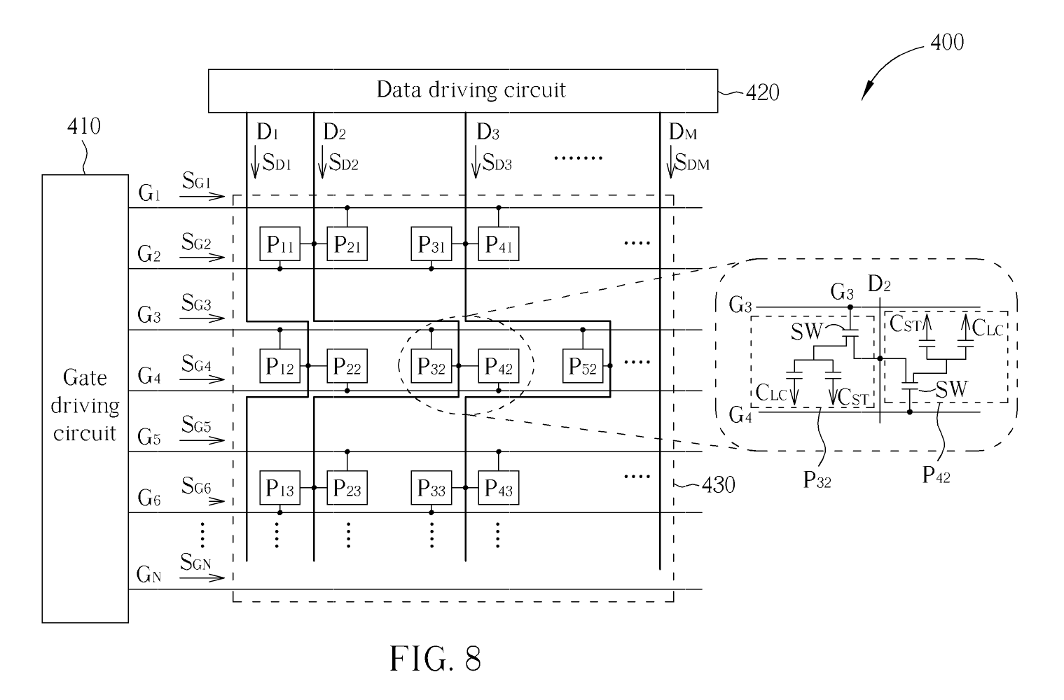

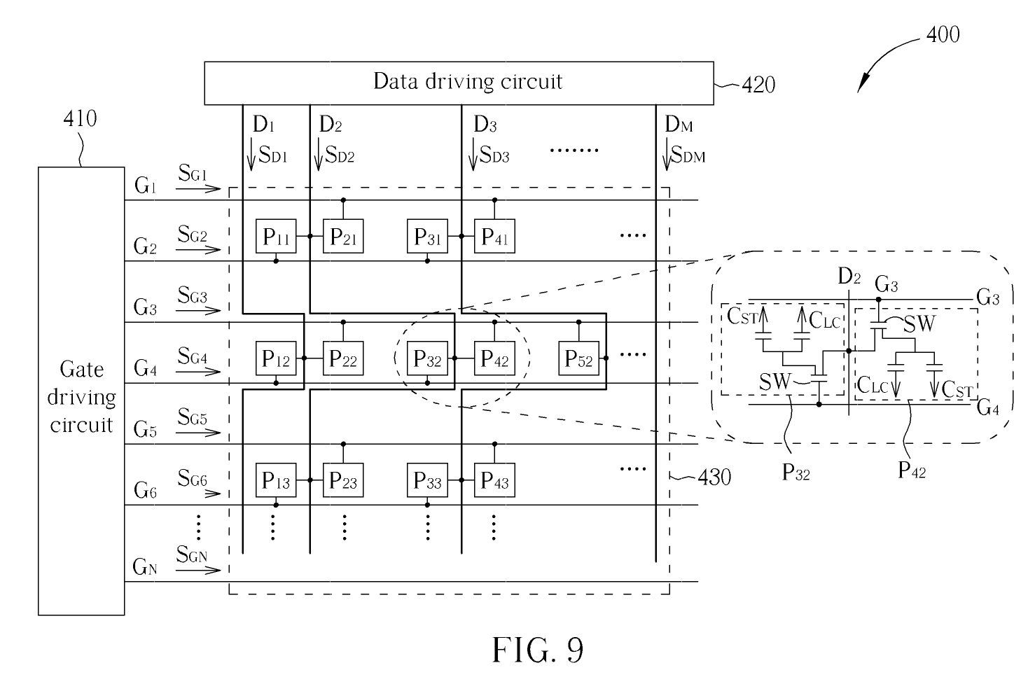

Please refer to FIG. 7, FIG. 8 and FIG. 9. FIG. 7, FIG. 8 and FIG. 9 are diagrams illustrating the LCDs of the second, third and fourth embodiments of the present invention. The structures of the LCDs of FIG. 7, FIG. 8 and FIG. 9 are similar to the LCD 400. The differences between LCDs in FIG. 4 and FIG. 7, FIG. 8, and FIG. 9 are that in FIG. 4, the pixels in the same column pairs are coupled to the gate lines in the same manner, but in FIG. 7, FIG. 8, and FIG. 9, the manner of the pixels in the same column pairs being coupled to the gate lines are different. For example, in FIG. 4, the pixel P₁₁ is coupled to the gate line G₁; the pixel P₂₁ is coupled to the gate line G₂; the pixel P₁₂ is coupled to the gate line G₃; the pixel P₂₂ is coupled to the gate line G₄; the pixel P₁₃ is coupled to the gate line G₅; the pixel P₂₃ is coupled to the gate line G₆. However, in FIG. 7, the pixel P₁₁, P₂₁, P₁₃, and P₂₃ are coupled as the same as in FIG. 4, but the pixel P₁₂ is coupled to the gate line G₄, and the pixel P₂₂ is coupled to the gate line G₃. In FIG. 9, the pixel P₁₁ is coupled to the gate line G₂; the pixel P₂₁ is coupled to the gate line G₁; the pixel P₁₂ is coupled to the gate line G₄; the pixel P₂₂ is coupled to the gate line G₃; the pixel P₁₃ is coupled to the gate line G₆; the pixel P₂₃ is coupled to the gate line G₅. In FIG. 8, the structure is quite similar to FIG. 9, and only the coupling for the pixels P₁₂ and P₂₂ is different: the pixel P₁₂ is coupled to the gate line G₃; the pixel P₂₂ is coupled to the gate line G₄. The coupling of the pixels is designed to meet some particular requirement and thus the different structures of FIG. 4, FIG. 7, FIG. 8, and FIG. 9 are consequently derived as desired. The related operation principle, as described above, is well-known to those skilled in the analogous art and will not be repeated again.

In conclusion, in the LCD provided by the present invention, since the data lines in the pixel area have the shape like the letter “S”, the data driving signals on the data lines does not have to be inverted within one frame. In this way, the power consumption of the LCD is saved, causing a great convenience.

Those skilled in the art will readily observe that numerous modifications and alterations of the device and method may be made while retaining the teachings of the invention.

What is claimed is:

1. An LCD with two-dot inversion, comprising:
a plurality of gate lines for transmitting gate driving signals;
a plurality of data lines for transmitting data driving signals; and
a pixel array, comprising a plurality of columns of pixels;
wherein each row of the plurality of the columns of the pixels comprises a pixel so as to form the pixel array and the pixel array displays images according to the received gate driving signals and the received data driving signals;
wherein one of the plurality of the columns of the pixels is disposed between two adjacent gate lines and between two adjacent data lines;
wherein a first data line of the plurality of the data lines is coupled to pixels of a first column of a first pair of the plurality of the columns of the pixels and to pixels of a second column of a second pair of the plurality of the columns of the pixels and the first column is separated from the second column by at least two columns.

2. The LCD of the claim 1, wherein the plurality of the data lines in the pixel array are curved lines with at least one bend, and the plurality of the gate lines are straight lines parallel with each other.

3. The LCD of the claim 1, wherein the first data line is coupled to a pixel corresponding to a first row of the first column of the first pair of the plurality of the columns of the pixels and a pixel corresponding to the first row of a third column adjacent to the first column of the first pair of the plurality of the columns of pixels; the first data line is coupled to a pixel corresponding to a second row of the second column of the second pair of the plurality of the columns of the pixels and a pixel corresponding to the second row of a fourth column adjacent to the second column of the second pair of the plurality of the columns of the pixels;
wherein the first and second rows are different.

4. The LCD of the claim 1, wherein a pixel of the plurality of the columns of the pixels comprises:
a pixel switch, comprising:
a first end, coupled to a data line corresponding to the pixel;
a second end; and
a control end, coupled to a gate line corresponding to the pixel;
a liquid crystal capacitor, coupled between the second end of the pixel switch and a common end; and
a storage capacitor, coupled between the second end of the pixel switch and the common end.

5. The LCD of the claim 4, wherein the pixel switch is a Thin Film Transistor (TFT), the control end of the pixel switch is a gate of the TFT.

6. The LCD of the claim 1, wherein polarity of a data driving signal of the first data line is opposite to polarity of a data driving signal of a second data line adjacent to the first data line.

7. The LCD of the claim 1, wherein polarities of the data driving signals transmitted by the first data line in a first frame are opposite to polarities of the data driving signals transmitted by the first data line in a second frame;
wherein the second frame is successive to the first frame.

8. The LCD of the claim 1, wherein the polarities of the data driving signals transmitted by the first data line in a frame are all the same.

9. The LCD of the claim 1, further comprising:
a gate driving circuit, coupled to the plurality of the gate lines for generating the plurality of the gate driving signals; and
a data driving circuit, coupled to the plurality of the data lines for generating the plurality of the data driving signals.

10. An LCD with two-dot inversion capable of saving power consumption, comprising:
a first, a second, a third and a fourth gate lines for transmitting gate driving signals;
a first and a second data lines for transmitting data driving signals; and
a pixel array, comprising:
a first pixel, disposed at a first row and a first column of the pixel array, coupled to the first gate line and the first data line for displaying images according to the received gate driving signals and the received data driving signals;
a second pixel, disposed at the first row and a second column of the pixel array, coupled to the second gate line and the first data line for displaying the images according to the received gate driving signals and the received data driving signals;
a third pixel, disposed at the first row and a third column of the pixel array, coupled to the first gate line and the second data line for displaying the images according to the received gate driving signals and the received data driving signals;
a fourth pixel, disposed at the first row and a fourth column of the pixel array, coupled to the second gate line and the second data line for displaying the images according to the received gate driving signals and the received data driving signals;
a fifth pixel, disposed at a second row and the third column of the pixel array, coupled to the third gate line and the first data line for displaying the images according to the received gate driving signals and the received data driving signals; and
a sixth pixel, disposed at the second row and the fourth column of the pixel array, coupled to the fourth gate line and the first data line for displaying the images according to the received gate driving signals and the received data driving signals.

11. The LCD of the claim 10, wherein the first and the second data lines in the pixel array are curved lines with at least one bend, and the first, the second, the third and the fourth gate lines in the pixel array are straight lines parallel to each other.

12. The LCD of the claim 10, wherein:
the first pixel comprises:
a pixel switch, comprising:
a first end, coupled to the first data line;
a second end; and
a control end, coupled to the first gate line;
a liquid crystal capacitor, coupled between the second end of the pixel switch of the first pixel and a common end; and
a storage capacitor, coupled between the second end of the pixel switch of the first pixel and the common end;
the second pixel comprises:
a pixel switch, comprising:
a first end, coupled to the first data line;
a second end; and
a control end, coupled to the second gate line;
a liquid crystal capacitor, coupled between the second end of the pixel switch of the second pixel and the common end; and
a storage capacitor, coupled between the second end of the pixel switch of the second pixel and the common end;
the third pixel comprises:
a pixel switch, comprising:
a first end, coupled to the second data line;
a second end; and
a control end, coupled to the first gate line;
a liquid crystal capacitor, coupled between the second end of the pixel switch of the third pixel and the common end; and
a storage capacitor, coupled between the second end of the pixel switch of the third pixel and the common end;
the fourth pixel comprises:
a pixel switch, comprising:
a first end, coupled to the second data line;
a second end; and
a control end, coupled to the second gate line;
a liquid crystal capacitor, coupled between the second end of the pixel switch of the fourth pixel and the common end; and
a storage capacitor, coupled between the second end of the pixel switch of the fourth pixel and the common end;
the fifth pixel comprises:
a pixel switch, comprising:
a first end, coupled to the first data line;
a second end; and
a control end, coupled to the third gate line;
a liquid crystal capacitor, coupled between the second end of the pixel switch of the fifth pixel and the common end; and
a storage capacitor, coupled between the second end of the pixel switch of the fifth pixel and the common end; and
the sixth pixel comprises:
a pixel switch, comprising:
a first end, coupled to the first data line;
a second end; and
a control end, coupled to the fourth gate line;
a liquid crystal capacitor, coupled between the second end of the pixel switch of the sixth pixel and the common end; and
a storage capacitor, coupled between the second end of the pixel switch of the sixth pixel and the common end.

13. The LCD of the claim 12, wherein the pixel switches of the first, the second, the third, the fourth, the fifth and the sixth pixels are Thin Film Transistors (TFT) and the control ends of the pixel switches are gates of the TFTs.

14. The LCD of the claim 10, wherein the polarities of the data driving signals transmitted by the first data line are opposite to the polarities of the data driving signals transmitted by the second data line.

15. The LCD of the claim 14, wherein the polarities of the data driving signals transmitted by the first data line in a first frame are opposite to the polarities of the data driving signals transmitted by the first data line in a second frame;
wherein the second frame is successive to the first frame.

16. The LCD of the claim 10, wherein the polarities of the data driving signals transmitted by the first data line in a frame are all the same and the polarities of the data driving signals transmitted by the second data line in the frame are all the same.

17. The LCD of the claim 10, further comprising:
a gate driving circuit, coupled to the plurality of the gate lines for generating the plurality of the gate driving signals; and
a data driving circuit, coupled to the plurality of the data lines for generating the plurality of the data driving signals.
